(19) United States
(12) Patent Application Publication
(10) Pub. No.: US 2020/0304681 A1
(43) Pub. Date: Sep. 24, 2020

(54) HALFTONE MATRICES COMPRISING DISTRIBUTED THRESHOLD VALUES

(71) Applicant: HEWLETT-PACKARD DEVELOPMENT COMPANY, L.P., Houston, TX (US)

(72) Inventors: Peter MOROVIC, Sant Cugat del Valles - Barcelona (ES); Jan MOROVIC, Colchester (GB); Tsuyoshi YAMASHITA, Corvallis, OR (US); Jake WRIGHT, San Diego, CA (US)

(73) Assignee: HEWLETT-PACKARD DEVELOPMENT COMPANY, L.P., Houston, TX (US)

(21) Appl. No.: 16/089,615

(22) PCT Filed: Oct. 25, 2016
(86) PCT No.: PCT/US2016/058669

§ 371 Date: Sep. 28, 2018

(51) Int. Cl. H04N 1/405; B29C 64/386; H04N 1/52

(52) U.S. Cl. CPC H04N 1/405; B33Y 50/02; H04N 1/52; B29C 64/386

(57) ABSTRACT

In an example, a method includes acquiring data representing an article to be printed. The data may include at least one element set associated with print addressable location(s) and comprising a first and second element. The elements each identify a print material or print material combination and is each associated with a probability that the print material or print material combination identified thereby is to be applied to the associated print addressable location. A halftone matrix may be acquired comprising threshold values of a first and second value range. The threshold values of the first and second value range are distributed according to a first and second distribution pattern respectively. The halftone matrix may be applied to the data to determine print instructions to distribute the print material or print material combination identified by the first and second element according to the first and second distribution patterns respectively.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation.

Examples of techniques used in converting data may include use of threshold matrices, in which a particular print material or material combination is assigned a probability of being applied in a particular location and the choice is made by comparing the probability values for the location to a threshold value. For example, a print material may be selected such that a drop of a particular color ink will be placed at a particular pixel to form an image.

### BRIEF DESCRIPTION OF DRAWINGS

For a more complete understanding, reference is now made to the following description taken in conjunction with the accompanying drawings in which:

FIG. 1 is a flowchart of an example method of applying a halftone matrix to data;

FIGS. 2A-2C are examples of halftone distributions;

FIG. 3 is a flowchart of an example method for printing an article;

FIG. 4 is a simplified schematic of an example non-transitory machine readable medium associated with a processor;

FIG. 5 is a simplified schematic of an example print data processing apparatus; and

FIG. 6 is a simplified schematic of an example print apparatus.

### DETAILED DESCRIPTION

In the case of two-dimensional printing, a print addressable location may comprise at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterised in terms of ‘voxels’, i.e. three-dimensional pixels, wherein each voxel occupies or represents a discrete volume. In examples of three-dimensional printing therefore, an addressable area may comprise at least one voxel and each voxel may be ‘printed’ i.e. generated or manufactured, using one or a combination of agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object. Some processes that generate three-dimensional objects use control data or print instructions generated from a model of a three-dimensional object. This control data may, for example, specify the locations at which to apply an agent to the build material, or where a build material itself may be placed, and the amounts to be placed. The control data may be generated from a 3D representation of an object to be printed. Locations may be expressed in terms of voxels. A voxel at a given location may have at least one characteristic. For example, it may be empty, may have a particular color or may represent a particular material, or a particular object property, or the like. In general, the voxels of an object may each have the same shape (for example, cubic or tetrahedral), or may differ in shape and/or size. However, where the term voxel is used herein to refer to a print addressable location, the voxel size may be determined at the print resolution of a print apparatus, i.e. it may correspond to a volume which can be individually addressed by a print apparatus (which may be a particular print apparatus, of a class of print apparatus, or the like) such that the properties thereof can be determined at least substantially independently of the properties of other voxels.

It may be that possible print materials to be applied to an addressable location are specified within an element set. In some examples, the print materials may be identified explicitly, i.e. in a set of elements comprising a set of print materials and/or print material combinations. In other examples, it may be that at least one of the elements of an element set relates to other qualities, which may in turn be related to print materials. For example, an element may specify a property or the like which can be mapped to print materials. In another example, a color may be specified in terms of a Neugebauer Primary (a set of the colors (and in some examples, the number of drops of printing agent) which can be applied by a particular print apparatus), which in turn may have predetermined mappings to colorants.

In some examples, a set of elements is expressed as a print material coverage representation which defines print material data, for example detailing (explicitly or implicitly, for example via a mapping) the amount of print materials (such as a colorant or coating for two dimensional printing or an agent(s) to be deposited onto a layer of build material, or in some examples, build materials themselves for three dimensional printing), and, if applicable, their combinations. Such print materials may be related to or selected to provide an image or object property such as, for example, color, transparency, flexibility, elasticity, rigidity, surface roughness, porosity, conductivity, inter-layer strength, density, and the like.

For example, a print addressable location within input data (for example, a pixel in image data or a voxel in object model data) may be associated with one or a set of print material coverage representations, for example, print material coverage vectors. In the case of two-dimensional printing, these may be referred to as area coverage vectors. For example, the vectors may comprise ink vectors, which specify proportions of inks to be applied (and may therefore be thought of as native to a printer) and/or Neugebauer Primary Area Coverage vectors (NPac vectors, or simply NPacs), which may specify colors in a manner which may be associated with inks or other colorants via a mapping (for example, using a look up table). By analogy, in three-dimensional printing, print agent vectors, which specify proportions of print agents to be applied and/or Material Volume coverage vectors (termed Mvoc vectors, or simply MVocs, herein) may be defined. Such coverage vectors may provide a probability that a print material may be applied in a location. In a simple case, such a vector may indicate that X% of a given region should have a particular print material applied thereto, whereas (100-X)% should be left clear of the print material. In practise, this may be resolved at the addressable resolution for the print material and/or printing device. Therefore, if there are N×M addressable locations in an XY plane associated with such a vector, X% of these locations may receive a print material, while (100-X)% do not.

Such a print material coverage representation may provide a plurality of values, wherein each value defines a probability for each, or each combination of print materials in an addressable location. For example, in a printing system with two available print materials (for example, inks, coatings or agents)—M1 and M2, where each print material may be independently deposited in an addressable area (e.g. voxel or pixel), there may be 2² (i.e. four) probabilities in a given material coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2. In this example, it is assumed that a drop of print material may be applied or not: i.e. a binary choice may be made and the value for each agent may be either 0 or 1. In this case, a coverage vector (or an element set) may be: [M1, M2, M1M2, Z] or with example probabilities [M1:0.2, M2:0.2, M1M2:0.5, Z:0.1]—in a set of print addressable locations (e.g. and [x, y] or an [x, y, z] location (which in some examples may be a [x, y] location in a z slice)) to which the coverage vector applies, 20% of locations are to receive M1 without M2, 20% are to receive M2 without M1, 50% are to receive M1 and M2 and 10% are to be left clear. As each value is a proportion and the set of values represent the available material combinations, the set of values in each vector sum to 1 or 100%.

Such a print material coverage vector or element set may therefore specify a plurality of elements which are related to print materials, and a probability for each element which is represented as a value between 0 and 1.

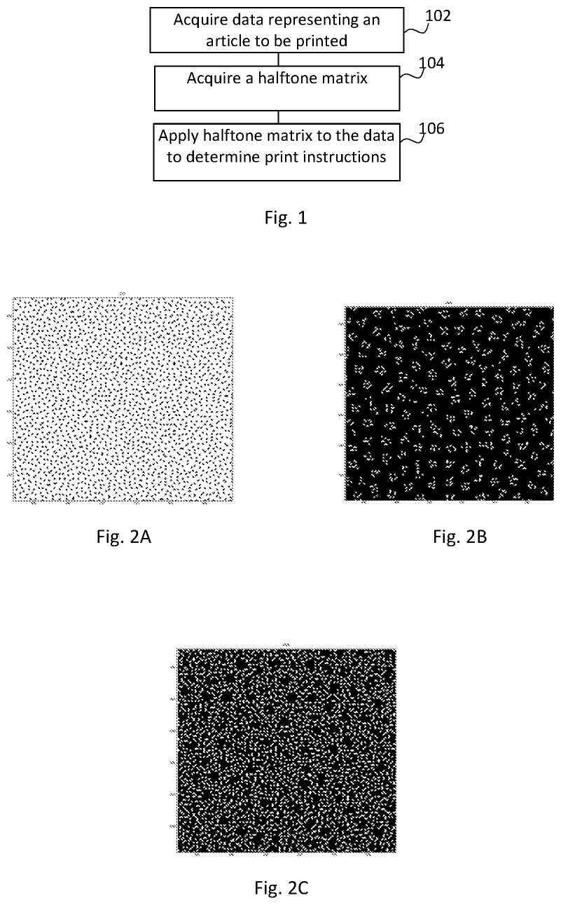

FIG. 1 is an example of a method, which may be a computer implemented method of determining print instructions. Block 102 comprises acquiring data representing an article to be printed. The article may for example comprise a substantially two dimensional image, for example a picture, pattern or text to be applied to a substrate such as paper, card or plastic. In other examples, the article may comprise an object to be printed using additive manufacturing techniques.

The data comprises at least one element set associated with at least one print addressable location, the element set(s) comprising a first element and a second element, wherein the first and second elements of the element set(s) identify a print material or print material combination and is each associated with a probability that the print material or print material combination identified by the element is to be applied to an associated print addressable location. The first and second elements may be the same and/or in different element sets. Such an element set may for example comprise a print agent coverage vector, which may for example comprise an ink vector, an NPac, print agent vector or an MVoc as described above. The associated print addressable location may comprise one or a plurality of pixels or voxels. In some examples, a plurality of print addressable locations are associated with an element set.

Block 104 comprises acquiring a halftone matrix. The halftone matrix comprises threshold values of a first value range and threshold values of a second value range, wherein the threshold values of the first value range are distributed according to a first distribution pattern and the threshold values of the second value range are distributed according to a second distribution pattern. In some examples, there may be further value ranges associated with further distribution patterns and/or with a transition pattern representing a transition between distribution patterns. In some examples, the halftone matrix may be acquired from a memory, or over a network or the like. In other examples, the halftone matrix may be generated, as described in greater detail below.

The first distribution and/or the second distribution (and/or further distribution(s)) may for example comprise at least one of a ‘blue noise’ distribution (which may be periodic or aperiodic), a cluster dot distribution, dispersed dot distribution, a ‘white noise’ random distribution, a regular ordered distribution, or other patterns, which in some examples may be specific to the intended properties of the agent applied as is further set out below.

In such a matrix, for example, if the total range of values is between 0 and 100, the values for 0 to 75 may be distributed with a first distribution pattern—for example a dispersed dot pattern, whereas a second range of values, for example between 76 and 100 may be distributed according to a different pattern, for example a clustered dot pattern or a dispersed dot pattern having different parameters. In one example, the first distribution pattern is a dispersed dot pattern and the second distribution pattern is a clustered dot pattern. In some examples, there may be more than two distribution patterns. In some examples, as further set out below, there may be a transitional region in which thresholds are distributed with attributes of both patterns.

It may be intended to use different halftone distribution patterns for different print agents/print agent combinations, whether to produce a substantially two dimensional image or in additive manufacturing to produce a three dimensional object. For example, color may create a visually pleasing effect when a dispersed dot halftoning pattern is used, but it may be intended that other agents are distributed in a more clustered manner, such as may be achieved using a clustered dot distribution. For example, in two dimensional printing, some coatings may provide better coverage when applied according to a clustered distribution pattern and in 3D printing it may create a particular surface texture. The methods set out herein allow such distributions to be achieved using a single halftone matrix.

In examples where the article is a three-dimensional object to be generated, the matrix may be a three dimensional matrix or may be two dimensional (for example, for use in generating a layer of the object), and may be applied once data representing the object has been rasterised into layers.

Block 106 comprises applying the halftone matrix to the data to determine print instructions to distribute the print material or print material combination identified by the first element according to the first distribution pattern and to distribute the print material or print material combination identified by the second element according to the second distribution pattern.

Determining which element is selected may comprise considering the elements of an element set in order. For example, an element set may be expressed as:

[M1:0.7, Z:0.2, M2:0.1]

Where M1 and M2 represent different print agents or print agent combinations, and Z represents an instruction not to apply any print agent. The halftone matrix may provide a threshold for each print addressable location at a print apparatus resolution (i.e. the halftone matrix may provide a threshold value for each print resolution pixel or voxel, or each region which the print apparatus can individually target when applying a print agent).

The element set may apply to more than one print resolution voxel/pixel. In a first example, a first pixel may be associated with a threshold value of 60 (or more generally of 60% of the range of threshold values). M1 may be applied to that location as the value does not exceed 0.7 allocated for M1. A second pixel may be associated with a threshold value of 75 (or more generally of 75% of the range of threshold values). In this case, 75% exceeds the probability associated with M1 (0.7), so a cumulative probability associated with M1 and Z (0.7+0.2=0.9) is determined. As 0.75 is greater than the probability associated with M1 (0.7) and is less than the cumulative probability of M1 and Z (0.9), no print agent is applied (as is represented by Z). A third pixel may be associated with a threshold value of 95 (or more generally of 95% of the range of threshold values). The first cumulative probability that exceeds 90% (M1+Z) is associated with M2, so when a threshold value is 0.95, M2 may be applied at this location.

In summary therefore, determining which element to select may be carried out by considering the elements in order, and comparing, on a location-by-location basis, each location of the data to a threshold value in a corresponding location in the matrix. Each element may be considered in order until the cumulative probability associated with that element and all previously considered elements is at least the threshold value (when considered as a proportion of the full range of threshold values) for that location.

To consider the example given above in which the first distribution pattern is a dispersed dot pattern and the second distribution pattern is a clustered dot pattern, the cumulative probability associated with Z may be such that no print agent is to be applied when the threshold value is in a range which overlaps, at least in part, one or both of the first value range and the second value range.

FIG. 2A shows a schematic example of a dispersed dot distribution (which may be referred to a ‘blue noise’ distribution) as black dots on a white background and FIG. 2B shows a schematic example of a clustered dot distribution as white dots on a black background. It may be noted that the clustered dot distribution shows more clustering than the dispersed dot noise distribution.

FIG. 2C represents a transition between a clustered dot and a dispersed dot distribution. Consider an example in which the values starting from 1 to 75 were distributed according to a dispersed dot distribution and the values starting from 100 to 76 in reverse order were distributed according to a clustered dot distribution. The values from 1 to 75 may be distributed first into all available locations. The values from 100 to 76 are distributed in ‘reverse order’ in the sense that the value 100 may be allotted to the remaining available locations first, followed by 99, then 98, etc. The choice of locations decreases as more locations fill. Thus, the higher values may more accurately represent the intended pattern as the distribution is less constrained by the presence of previously filled locations. As the values approach 76, the choice of remaining empty locations becomes small and, under such a constraint, the intended pattern may not be represented as well as for the higher numbers. In practice, the distribution will tend to take on some of the characteristics of the dispersed dot distribution used for the first value range. In such an example, FIG. 2A may be similar to a distribution for the numbers 1 to 75, FIG. 2B may be similar to a distribution pattern for the numbers 90 to 100 and, FIG. 2C may be similar to a distribution pattern for the numbers in the 75-80 range.

In an element set having the form [M1: 0.3, Z: 0.7], the print pattern produced of M1 would represent a well dispersed dot pattern following the dispersed dot distribution created for levels 1 to 75. If an element set having the form [Z: 0.9, M2: 0.1], the print pattern produced would of M2 would represent a cluster dot distribution created for values 100 to 76 in reverse order. Levels near the transition point of 75 may represent a transitioning of the characteristics of the distribution from dispersed to clustered dot. For example, it may be that, rather than being a hard boundary between a dispersed dot distribution and a clustered dot distribution, the change may be gradual such that, for a boundary range of values, some attributes of both patterns will be apparent. For example, the values between 76 and 90 may exhibit increasing clustering until an intended degree of clustering is reached. Thus, there may be a third set of threshold values with a distribution pattern which transitions between the first distribution and the second distribution. This may correspond to a range in which the values are distributed according to a particular pattern, but the distribution is constrained by a scarcity of locations in which to disperse the values. The limits of this value range may be determined based on the context (for example, in the above case or transitioning between two patterns, the upper end of the third set of values may be determined based on when the characteristics of the distribution sufficiently conform to the second pattern given an intended application). In some examples, the third set of threshold values may be associated with the application of a non-print element.

In some examples, the element sets may be arranged such that a non-print element is selected for at least some values which fall within such a transition between patterns, for example such that print elements may be distributed to more accurately conform to a particular distribution pattern.

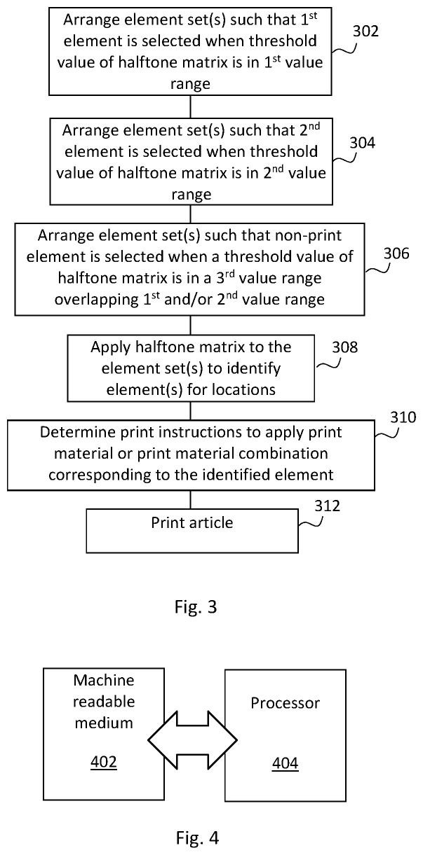

FIG. 3 is an example of a method, which may be a computer implemented method, and which may be carried out in conjunction with the method of FIG. 1. Block 302 comprises arranging the element set(s) such that the first element is selected when a threshold value of the halftone matrix for a location corresponding to the print addressable location of the element set has a value of first value range. Block 304 comprises arranging the element set(s) such that the second element is selected when a threshold value of the halftone matrix for a location corresponding to the print addressable location of the element set has a value of second value range.

In an example in which the threshold values of the first value range (i.e. the range distributed according to the first distribution) comprise the lowest threshold value (e.g. 0 in the example above) and the threshold values of the second value range (those distributed according to the second distribution) comprise the highest threshold value (e.g. 100 in the example above), such a method may comprise arranging the element set such that the cumulative probabilities for all elements up to and including the first element lies within a band corresponding to the proportion of threshold values which are within the first value range and wherein the cumulative probability for all elements up to (but excluding) the second element lies within a band which is at least the proportion of threshold values which are not within the second value range.

In other words, the order of the element set may be determined based on the distributions of the values. For example, with an element set of [M1:0.4, Z:0.5, M2:0.1], M2 is distributed according to the second distribution pattern as the cumulative probability associated therewith means that it will be selected when the threshold values are in the range 90-100. In examples in which the values 76-100 are distributed according to the second pattern, this means that the distribution of M2 will follow this pattern. However, if the element set were arranged in a different manner, for example as [M2:0.1, M1:0.7, Z:0.2], then M2 would be placed in locations corresponding to values distributed according to the first distribution, and M1 would be distributed in a mixed manner: some of the locations would corresponds to values (11-75) distributed according to the first distribution pattern as this range will populate values 0-75 within the matrices, whereas other locations would corresponds to values 71-75 distributed according to the second distribution pattern. In other words, while in some examples, elements may be distributed according to a single distribution pattern (i.e. the range of probabilities associated with an element is within a single threshold value range, but some examples, elements maybe the range of probabilities associated with an element is within a plurality of threshold value ranges, so as to be distributed according to a plurality of distribution patterns.

Where there are more than two patterns to be considered, each value range and element set order may be selected appropriately.

In some examples, therefore, the element set may be arranged such that the cumulative probabilities associated with a particular element correspond to the appropriate value range (i.e. a value range spanning a corresponding proportion of the total value range), given an intended distribution pattern.

Moreover, in the example of FIG. 3, at least one element set comprises at least one non-print element indicative that no print agent is to be applied to the print addressable location (Z in the example above), and the method comprises in block 306 arranging the element set such that the non-print element is selected when a threshold value of the halftone matrix for a location corresponding to the print addressable location of the element set has a value in a third value range, wherein the third value range overlaps at least in part with at least one of the first and second value range.

This may comprise arranging at least one element set such that the cumulative probabilities associated with the non-print element is such that the non-print agent will be selected for a value range spanning the value range associated with the first distribution pattern and a value range associated with the second distribution pattern.

This may for example comprise arranging an element set such that a range between (i) the cumulative probabilities for all elements up to the non-print element and (ii) the cumulative probabilities for all elements up to and including the probability non-print element comprises a value corresponding to proportion of the total value range for threshold values which is associated with the first and/or second distribution pattern.

By ensuring that the non-printing element is selected in a boundary region associated with a switch between a two distribution patterns, a ‘buffer’ may be provided between patterns which may ensure each printed element is dispersed according to its intended pattern. As such a non-print element is provided in a number of print applications, this represents a useful position in which such an element may be placed. In some examples, where there are more than two distribution patterns intended for the elements, there may also be more than one range of probabilities associated with applying no print agent, i.e. there may be at least two non-print elements and the possibility associated with selecting a non-print element may be dispersed throughout the element set. For example, such an element set may be expressed as [M1:a, Z:b, M2:c, Z:d, M3:e], where the values of a, b, c, d and e sum to 1, and M1, M2 and M3 are to be distributed according to different distribution patterns.

Block 308 comprises applying the halftone matrix to the data on a location-by-location basis to the data representing the article to be printed to identify which element is associated with a cumulative probability corresponding to the threshold, wherein cumulative probability is determined by summing the probability of that element and all preceding elements in the element set. Block 310 comprises determining print instructions comprising an instruction that the print material or print material combination corresponding to the identified element for that location is printed (or that no print agent is printed). Block 312 comprises printing an article (be that an image on a substrate or a three dimensional object) based on the print instructions.

In the example of FIG. 3, it is assumed that the element set is arranged based on the structure of the matrix, although in other examples, the matrix could be designed at least in part based on at least one element set.

For example, it may be the case that an image is to be printed with a coating at a 10% coverage, and with a clustered dot distribution for that coating. This could inform the choice of the value range which is associated with each pattern distribution range, and a choice of whether the lower or higher values are distributed according to the clustered dot distribution could be made (if the lower values are selected, the vectors/element sets may be ordered such that the coating appears first, followed by other print agents). This in turn may influence the placement of the element indicative of the coating within the element set.

In some examples, a selection may be made as to which set of values are distributed first. This may be determined according to a priority, which may for example be user determined or predetermined. For example, when distributing a first selected value range, there may be choice of all locations in the matrix, but when distributing a second value range, this may populate the remaining unpopulated slots. This may mean that the pattern which is used to populate the matrix first better conforms to the intended pattern attributes than the pattern used to populate the matrix subsequently, which is subject to some constraints. In other examples, the distribution of values may be intermixed, or phased, to reduce such influences.

Moreover, unless there is a threshold number of locations available to populate, it may be that a physical distribution of points will not result in an intended effect. Therefore, in some examples, there may be a minimum proportion of values for each value range. The presence of a non-print element may be helpful in allowing the range of values which may be distributed according to the pattern to exceed the proportion of location expected to receive that print agent according to a pattern, and/or in providing a transition region between a first and second distribution pattern which will not be apparent in the printed article.

In some examples, it may be the case that element sets vary significantly over an article to be printed. In some examples, object portions may be processed in parallel using differently contracted halftone matrices to reflect the structure of the element sets. The resulting halftone print instructions could be merged before printing. However, in some examples, it may be that different element sets can be processed using the same matrix. To consider an example it may be that, whatever the color choice, a coating at 10% coverage is to be applied across an image. Such element sets could be processed using the 75:25 matrix described above.

FIG. 4 shows an example of a non-transitory machine-readable medium 402 in association with a processor 404. The machine-readable medium 402 has instructions stored thereon, that when executed by a processor 404, cause the processor 404 to populate a first set of locations in a halftone matrix with a first set of threshold values according to a first distribution and to populate a second set of locations in a halftone matrix with a second set of threshold values according to a second distribution. The first set of threshold values are in a first value range and the second set of threshold values are in a second value range, and each location in the first set is different to each location in the second set.

As noted above, in some examples a choice may be made as to which pattern is associated with the higher priority. In an example, the first distribution pattern is a dispersed dot pattern and values in the first value range may be distributed using a “void and cluster” algorithm with appropriate parameters. This fills a proportion of the locations in the matrix corresponding to the proportion of the value range which the first value set occupies. In this example, the first value range comprises the first X% of the values, and X% of locations in the matrix are populated using dispersed dot distribution parameters (for example, using a Gaussian filter). In other examples, there may be some locations left unoccupied (i.e. the first X% of the values may populate Y% of locations, where Y is less than X). A different set of parameters may be used for the void and cluster algorithm (for example, a filter designed to create a clustered dot distribution) to fill the remaining 100-X% of locations.

In some examples, when distributing the first X% of the values, the locations may be selected using the appropriate void and cluster algorithm. When populating the second set of values, the additional locations may be selected by choosing, from the remaining unoccupied locations, the locations to be filled in reverse order from 100 to X+1% using the appropriate void and cluster algorithm parameters to create a clustered dot distribution. In practice, while consistent parameters may be used, this distribution may be increasingly constrained by the increasing scarcity of unpopulated locations. This may result in the processor 404 populating some locations with a third set of threshold values which have a distribution pattern which transitions between the first distribution and the second distribution.

The instructions may be such that the locations in the halftone matrix are populated such that the first and second value ranges are non-overlapping. In some examples, the non-transitory machine-readable medium 402 may have further instructions stored thereon, which when executed by the processor 404, cause the processor 404 to, on receipt of data on receipt of data representing an article to be printed as at least one print material coverage vector comprising a first element to be printed with the first distribution and the second element is to be printed with a second distribution and corresponding to at least one print addressable location of the article, compare, on a location-by-location basis, the print material coverage vector to a threshold value in a corresponding location in the halftone matrix. This may allow selection of an element.

In some examples, the instructions may cause the processor 404 to select each element of a print material coverage vector in order until the cumulative probability associated with that element and all previously selected elements is at least the threshold value for that location.

In some examples, the instructions to populate the matrix may comprise instructions to populate the matrix such that the first value range comprises values in a first proportion of a total value range which includes the probability of cumulative probability associated with the first element, and the second value range comprises values in a second proportion of a total value range which includes the probability of cumulative probability associated with the second element will be selected. As has been noted above, in some examples, the value range for one or both patterns may extend in to a region of values corresponding to a non-printing element. In some examples, the ranges of values may correspond to a sufficient range of values to adequately represent a pattern such that intended behaviours or effects are seen.

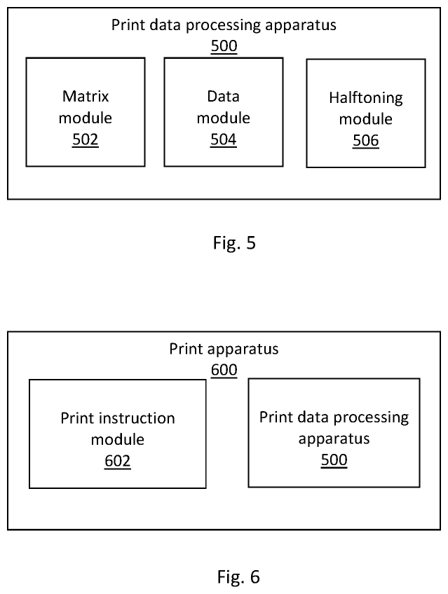

FIG. 5 is an example of a print data processing apparatus 500, which is adapted to determine print instructions to distribute a first print material or print material combination according to a first distribution pattern and print instructions to distribute a second print material or print material combination according to a second distribution pattern. The print data processing apparatus 500 comprises a matrix module 502, a data module 504 and a halftoning module 506.

The matrix module 502 is configured to acquire a halftone matrix in which threshold values in a first value range are distributed according to the first distribution pattern and threshold values in a second value range are distributed according to the second distribution pattern. In some examples, the matrix module may generate the halftone matrix using the principles outlined above. In other examples, the matrix module 502 may acquire the matrix from another source, for example a memory, or over a network, or the like.

The data module 504 is configured to acquire data representing an article to be printed comprising an element set associated with each of a plurality of print addressable locations, the element set comprising a first element and a second element, wherein each element of the element set identifies a print material or print material combination, or is a non-print element and is associated with a probability that the print material or print material combination identified by the element, or that no print material, is to be applied to a print addressable location.

The halftoning module 506 is configured to apply the halftone matrix on a location-by-location basis to the data representing the article to be printed to identify which element is associated with a cumulative probability corresponding to the threshold, wherein cumulative probability is determined by summing the probability of that element and all preceding elements in the element set. The halftoning module 506 may be configured to select, from a set of elements (for example, an ink vector, print agent vector, an NPac or an Mvoc as described above, which may be from input data) an element for a first print addressable location (for example a pixel or a voxel). Some elements may be associated with a print material or print material combination, either explicitly or implicitly, for example via a mapping or look up table.

FIG. 6 is an example of a print apparatus 600, which comprises the print data processing apparatus 500 of FIG. 5 as well as a print instruction module 602 to determine print instructions based on elements identified by the halftoning module 506. The print instruction module 602 determines print control data comprising instructions for the print apparatus 600 to print using the materials or material combinations specified by selected elements in each print addressable location. The print apparatus 600 carries out a print operation (which may be two dimensional or three dimensional print operation) according to the control data.

The print apparatus 600 is configured to print an article according to print instructions/control data, and to that end may comprise additional print apparatus components such as one or more print heads, one or more print agent supplies, and the like. Where the print apparatus is a ‘two dimensional’ printer, it may comprise a laser printer or an inkjet printer or the like, and may comprise a print head, substrate handling systems, sources of inks or toner, and the like. Where the printer is a ‘three dimensional’ printer, it may comprise, or be associated with, a print bed, a fabrication chamber, a print head, one or more energy sources, a source of build material, or the like.

The print data processing apparatus 500, matrix module 502, data module 504, halftoning module 506, and print instruction module 602 may be implemented with one or a plurality of processors executing machine readable instructions stored in a memory, or a processor operating in accordance with instructions embedded in logic circuitry. It is noted that in at least one example described herein, the term “module” refers to a hardware component of the apparatus.

Examples in the present disclosure can be provided as methods, systems or machine readable instructions, such as any combination of software, hardware, firmware or the like. Such machine readable instructions may be included on a non-transitory machine (for example, computer) readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus, or a module thereof, may execute the machine readable instructions. Thus functional modules of the apparatus 500, 600 (for example, the matrix module 502, data module 504, halftoning module 506, and print instruction module 602) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
acquiring data representing an article to be printed, the data comprising at least one element set associated with at least one print addressable location, the at least one element set comprising a first element and a second element, wherein the first and second element each identifies a print material or print material combination and is associated with a probability that the print material or print material combination identified by that element is to be applied to the associated print addressable location;
acquiring a halftone matrix, the halftone matrix comprising threshold values of a first value range and threshold values of a second value range, wherein the threshold values of the first value range are distributed according to a first distribution pattern and the threshold values of the second value range are distributed according to a second distribution pattern; and
applying the halftone matrix to the data to determine print instructions to distribute the print material or print material combination identified by the first element according to the first distribution pattern and to distribute the print material or print material combination identified by the second element according to the second distribution pattern.

2. A method according to claim 1 further comprising arranging the at least one element set such that:
the first element is selected when a threshold value of the halftone matrix for a location corresponding to the print addressable location of an element set has a value of first value range; and
the second element is selected when a threshold value of the halftone matrix for a location corresponding to the print addressable location of an element set has a value of second value range.

3. A method according to claim 1 in which at least one element set comprises a non-print element indicative that no print agent is to be applied to the print addressable location, and the method comprises arranging the element set such that the non-print element is selected when a threshold value of the halftone matrix for a location corresponding to the print addressable location of the element set has a value in a third value range, wherein the third value range overlaps at least in part with at least one of the first and second value ranges.

4. A method according to claim 1 in which the halftone matrix comprises threshold values of a third value range, wherein the threshold values of the third value range are distributed according to a third distribution pattern and at least one element set comprises at least two non-print elements indicative that no print agent is to be applied to the print addressable location, and the method comprises arranging the element set such that a non-print element is selected when a threshold value of the halftone matrix for a location corresponding to the print addressable location of the element set has a value in a value range which spans value ranges associated with different distribution patterns.

5. A method according to claim 1 in which applying the halftone matrix to the data to determine print instructions comprises applying the halftone matrix on a location-by-location basis to the data representing the article to be printed to identify an element associated with a cumulative probability corresponding to the threshold, wherein the cumulative probability is determined by summing a probability for that element and all preceding elements in an element set until a cumulative probability associated with that element and all preceding elements is at least the threshold value for that location; and
determining print instructions comprises determining an instruction that the print material or print material combination corresponding to the identified element for each of a plurality of locations is printed at a corresponding location.

6. A method according to claim 1 further comprising printing an article based on the print instructions.

7. A non-transitory machine-readable medium with instructions stored thereon that, when executed by a processor, cause the processor to:
populate a first set of locations in a halftone matrix with a first set of threshold values according to a first distribution, and populate a second set of locations in a halftone matrix with a second set of threshold values according to a second distribution, wherein
the first set of threshold values are in a first value range and the second set of threshold values are in a second value range; and
each location in the first set of locations is different to each location in the second set of locations.

8. A non-transitory machine-readable medium according to claim 7 with further instructions stored thereon, which when executed by a processor, cause the processor to populate a third set of locations in a halftone matrix with a third set of threshold values with a distribution pattern which transitions between the first distribution the second distribution.

9. A non-transitory machine-readable medium according to claim 7 with further instructions stored thereon, which when executed by a processor, cause the processor to, on receipt of data representing an article to be printed as at least one print material coverage vector comprising a first element to be printed with the first distribution and a second element to be printed with a second distribution and corresponding to at least one print addressable location of the article, compare, on a location-by-location basis, the print material coverage vector to a threshold value in a corresponding location in the halftone matrix.

10. A non-transitory machine-readable medium according to claim 9 wherein
the elements of each print material coverage vector are arranged in an order; and
comparing on a location-by-location basis, each location to a threshold value in a corresponding position comprises selecting each element in the order until a cumulative probability associated with that element and all previously selected elements is at least the threshold value for that location.

11. A non-transitory machine-readable medium according to claim 10 in which the locations in the halftone matrix are populated such that:
the first value range comprises values in a first proportion of a total value range which include a cumulative probability associated with the first element; and
the second value range comprises values in a second proportion of a total value range which include a cumulative probability associated with the second element.

12. A non-transitory machine-readable medium according to claim 7 wherein the locations in the halftone matrix are populated such that at least one of the first distribution and the second distribution comprises at least one of: a periodic or an aperiodic blue noise distribution, a dispersed dot distribution, a clustered dot distribution, a white noise random distribution.

13. A print data processing apparatus to determine print instructions to distribute a first print material or print material combination according to a first distribution and print instructions to distribute a second print material or print material combination according to a second distribution comprising:
a matrix module to acquire a halftone matrix in which threshold values in a first value range are distributed according to a first distribution pattern and threshold values in a second value range are distributed according to a second distribution pattern;
a data module to acquire data representing an article to be printed comprising an element set associated with each of a plurality of print addressable locations, the element set comprising a first element and a second element, wherein each element of the element set identifies a print material or print material combination or is a non-print element and is associated with a probability that the print material or print material combination identified by the element is to be applied to a print addressable location, or that no print material is to be applied to the print addressable location; and
a halftoning module to apply the halftone matrix on a location-by-location basis to the data representing the article to be printed to identify which element is associated with a cumulative probability corresponding to the threshold value for that location, wherein cumulative probability is determined by summing a probability for that element and all preceding elements in the element set.

14. A print data processing apparatus according to claim 13 further comprising a print instruction module to determine print instructions based on elements identified by the halftoning module.

15. A print data processing apparatus according to claim 14 further comprising print apparatus to print an article according to print instructions.
